(19) United States
(12) Patent Application Publication
(10) Pub. No.: US 2015/0139764 A1
(43) Pub. Date: May 21, 2015

(54) EMPTY VEHICLE LIFTER FOR VEHICLE ASSEMBLY LINE

(71) Applicants: Hyundai Motor Company, Seoul (KR); Kia Motors Corporation, Seoul (KR)

(72) Inventors: Heon Min Jang, Incheon (KR); Byung Chan Park, Ansan-si (KR)

(73) Assignees: Hyundai Motor Company, Seoul (KR); Kia Motors Corporation, Seoul (KR)

(21) Appl. No.: 14/452,212

(22) Filed: Aug. 5, 2014

(30) Foreign Application Priority Data
Nov. 15, 2013 (KR) 10-2013-0139252

(51) Int. Cl. B66F 7/12; B60S 9/04

(52) U.S. Cl. CPC B66F 7/12; B60S 9/04
USPC 414/458

(57) ABSTRACT

Disclosed is an empty vehicle lifter for a vehicle assembly line. The empty vehicle lifter for a vehicle assembly line may lift a vehicle in an empty vehicle condition in a vehicle assembly line, and may include: i) four post frames which are substantially vertically installed on a floor of a working place while corresponding to wheels of the vehicle, ii) a ceiling frame which is connected to upper end portions of the post frames, iii) a tire ground contact unit which supports a wheel tire of the vehicle, and is installed on each of the post frames so as to be movable upward and downward, and iv) a lift unit which is installed on the ceiling frame so as to move the tire ground contact unit upward and downward.

### CROSS-REFERENCE TO RELATED APPLICATION

The present application claims priority of Korean Patent Application Number 10-2013-0139252 filed on Nov. 15, 2013, the entire contents of which application are incorporated herein for all purposes by this reference.

### BACKGROUND OF INVENTION

1. Field of Invention

The present invention relates to a vehicle assembly system, and more particularly, to an empty vehicle lifter for a vehicle assembly line which is provided to perform under body work and repair work on a vehicle in an empty vehicle condition.

2. Description of Related Art

In general, when vehicle makers produce vehicles, the vehicles are manufactured through numerous processes of welding and assembling tens of thousands of components in all mass production factories. In the mass production process of producing the vehicle, vehicle bodies and corresponding components are conveyed in working processes by conveying devices, and the working processes are efficiently managed by achieving process automation.

Particularly, in the mass production factories that produce vehicles, a design component assembly process is a process of assembling an engine, a transmission, a suspension system, and other constituent components in the vehicle body, and components are mounted to the vehicle body that is loaded into each process line by a main hanger. That is, in the design component assembly process, various types of components are assembled to corresponding mounting positions of the vehicle body in a trim line, and in a subsequent process, other components are assembled to the vehicle body in a final line.

Meanwhile, in the design component assembly process, a vehicle in an empty vehicle condition may be conveyed using conveying equipment such as an overhead hanger, an under body of the vehicle may be fastened and assembled, and the vehicle may be transferred from the overhead hanger to a conveyor and the like by a transferring device.

Here, the empty vehicle condition means a condition in which an empty vehicle weight of the vehicle may be satisfied, that is, an empty vehicle condition in which all design components including wheels, tires, and the like are mounted to a vehicle body, and may also mean a condition in which components associated with driving operations of the wheels are mounted to the vehicle body.

In addition, conveying equipment for conveying the vehicle in an empty vehicle condition means equipment that may convey the vehicle to various types of assembly processes in a state in which tires are in contact with the ground using the overhead hanger, and may transfer the vehicle to the conveyor on the floor of the working place using the transferring device for inline vehicle assembly processes.

In the meantime, in the inline vehicle assembly process where equipment for conveying the overhead hanger is not provided due to restriction conditions such as an equipment space and excessive remodeling costs, it is impossible to perform work for assembling the vehicle in an empty vehicle condition. For this reason, in the related art, work for fastening/assembling the under body of the vehicle and repair work on design components are performed while the vehicle is lifted by a separate lifter while off line.

A general lifter has a pair of supports which supports both sides of the vehicle, and a drive structure which is disposed below the supports, and reciprocally moves the supports upward and downward.

Therefore, in the related art, a working space for fastening and assembling the under body of the vehicle in an empty vehicle condition is narrow because of structural characteristics of the lifter, and it is difficult to perform the work for fastening/assembling the under body of the vehicle and the repair work on the design components due to interference between working tools and the support, and interference between a worker and the support.

For example, in the related art, it is impossible to perform torque work on a trailing arm and work for assembling a floor undercover due to the interference between the working tools and the lifter support, and it is impossible to perform work on seal side molding due to the interference between the worker and the lifter support.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an empty vehicle lifter for a vehicle assembly line which allows work for assembling an under body of a vehicle in an empty vehicle condition and repair work on design components to be easily performed in a case in which it is difficult to implement a work condition of the vehicle in an empty vehicle condition, which uses a tire ground contact type overhead hanger, due to an equipment space and excessive remodeling costs.

Various aspects of the present invention provide an empty vehicle lifter for a vehicle assembly line, which lifts a vehicle in an empty vehicle condition in a vehicle assembly line, the empty vehicle lifter including: four post frames which are substantially vertically installed on a floor of a working place while corresponding to wheels of the vehicle; a ceiling frame which is connected to upper end portions of the post frames; a tire ground contact unit which supports a wheel tire of the vehicle, and is installed on each of the post frames so as to be movable upward and downward; and a lift unit which is installed on the ceiling frame so as to move the tire ground contact unit upward and downward.

The empty vehicle lifter may further include a slider which is connected with the tire ground contact unit, coupled to a respective post frame so as to be slidable upward and downward, and connected with the lift unit through the respective post frame. The empty vehicle lifter may further include a wheel base adjustment unit which is connected with the slider and the tire ground contact unit in order to move the tire ground contact unit in a forward and rearward direction of the vehicle while corresponding to a predetermined wheel base of the vehicle. The empty vehicle lifter may further include a position fixing unit which is installed on the slider and the respective post frame, and fixes a raised position of the slider.

The post frames may be formed in a hollow square column shape.

The tire ground contact unit may include a ground contact base with which the wheel tire of the vehicle is in contact, and stopper members which are hingedly and rotatably coupled to front and rear sides of the ground contact base. The stopper members may support front and rear sides of the wheel tire through inner portions thereof while being rotated about hinge points by their own weights when the tire ground contact unit is moved upward.

The lift unit may include: drive motors which are installed on the ceiling frame between one pair of post frames, and between the other pair of post frames, respectively; a rotation shaft which is connected with each of the drive motors through a driving chain, and rotatably installed on the ceiling frame; a lift sprocket which is installed on the rotation shaft; a lift chain which is coupled to the lift sprocket, and has one end portion that is connected to the slider; and a weight member which is connected to the other end portion of the lift chain.

A driving sprocket may be installed on a drive shaft of a respective drive motor, a driven sprocket may be installed on the rotation shaft that corresponds to the driving sprocket, and the driving chain may connect the driving sprocket and the driven sprocket. The ceiling frame may have a first guide hole which guides the lift chain to an inside of the respective post frame, and a second guide hole which guides the lift chain to an outside of the respective post frame.

Guide rails may be installed on front and rear surfaces of the respective post frame in an upward and downward direction. The slider may include: a main slide bracket which is disposed in a forward and rearward direction of the vehicle while corresponding to an inside of the respective post frame; and sub-slide brackets which are installed on the main slide bracket while corresponding to front and rear sides of the respective post frame. A plurality of first guide rollers may be installed on the sub-slide bracket to be in rolling contact with both surfaces of a respective guide rail, and a plurality of second guide rollers may be installed to penetrate the sub-slide bracket so as to be in rolling contact with the respective guide rail.

The wheel base adjustment unit may include: a servo motor which is installed on the slider; at least one rail block which is installed on the slider in the forward and rearward direction of the vehicle; a lead screw which is disposed substantially in parallel with the rail block, connected with the servo motor, and rotatably installed on the slider; and a movable block which is connected with the tire ground contact unit, and coupled to the lead screw in a threaded connection manner.

The position fixing unit may include: a latch member which is installed in an upward and downward direction outside the respective post frame, and has latch grooves that are continuously formed in the upward and downward direction; and a locating cylinder which is installed on the slider, and has a stopper which is coupled to the latch groove, and installed on an end portion of an operation rod.

A stopping block, which restricts a maximum raised position of the slider, may be installed on each of the post frames.

The empty vehicle lifter may further include a weigher which is embedded in the tire ground contact unit, and measures a weight of the vehicle.

According to various aspects of the present invention, the vehicle may be moved upward and downward by moving the tire ground contact unit, which allows the wheel tire of the vehicle to be in contact with the tire ground contact unit, upward and downward through the slider by an operation of the lift unit.

Accordingly, according to various aspects of the present invention, the vehicle in an empty vehicle condition is lifted, thereby performing work for fastening and assembling the under body of the vehicle, and repair work on the design components, in a case in which it is difficult to implement a working environment condition of the vehicle in an empty vehicle condition, which uses a tire ground contact type overhead hanger, due to an equipment space and excessive remodeling costs in the automotive design component assembly process.

In addition, according to various aspects of the present invention, a working space for performing the work for fastening and assembling the under body of the vehicle in an empty vehicle condition and the repair work on the design components may be ensured, and interference with the working tools and interference with the worker may be avoided, thereby easily performing the work for assembling the under body of the vehicle in an empty vehicle condition and the repair work on the design components.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The drawings are intended to be used as references for describing the exemplary embodiments of the present invention, and the accompanying drawings should not be construed as limiting the technical spirit of the present invention.

FIG. 1 is a perspective view illustrating an exemplary empty vehicle lifter for a vehicle assembly line according to the present invention.

FIG. 2 is a view illustrating a tire ground contact unit that is applied to an exemplary empty vehicle lifter for a vehicle assembly line according to the present invention.

FIG. 3 is a view illustrating a slider that is applied to an exemplary empty vehicle lifter for a vehicle assembly line according to the present invention.

FIGS. 4 to 6 are views illustrating a lift unit that is applied to an exemplary empty vehicle lifter for a vehicle assembly line according to the present invention.

FIG. 7 is a view illustrating a wheel base adjustment unit that is applied to an exemplary empty vehicle lifter for a vehicle assembly line according to the present invention.

FIG. 8 is a view illustrating a position fixing unit that is applied to an exemplary empty vehicle lifter for a vehicle assembly line according to the present invention.

FIG. 9 is a view illustrating a modified example of a tire ground contact unit that is applied to an exemplary empty vehicle lifter for a vehicle assembly line according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A part irrelevant to the description will be omitted to clearly describe the present invention, and the same or similar elements will be designated by the same reference numerals throughout the specification. The size and thickness of each component illustrated in the drawings are shown for understanding and ease of description, but the present invention is not limited thereto. Thicknesses of several portions and regions are enlarged for clear expressions.

Further, in the following detailed description, names of constituents, which are in the same relationship, are divided into “the first”, “the second”, and the like, but the present invention is not necessarily limited to the order in the following description. Throughout the specification and the claims, unless explicitly described to the contrary, the word “comprise” and variations such as “comprises” or “comprising” will be understood to imply the inclusion of stated elements but not the exclusion of any other elements. In addition, “unit”, “means”, “part”, “member”, or the like, which is described in the specification, means a unit of a comprehensive configuration that performs at least one function or operation.

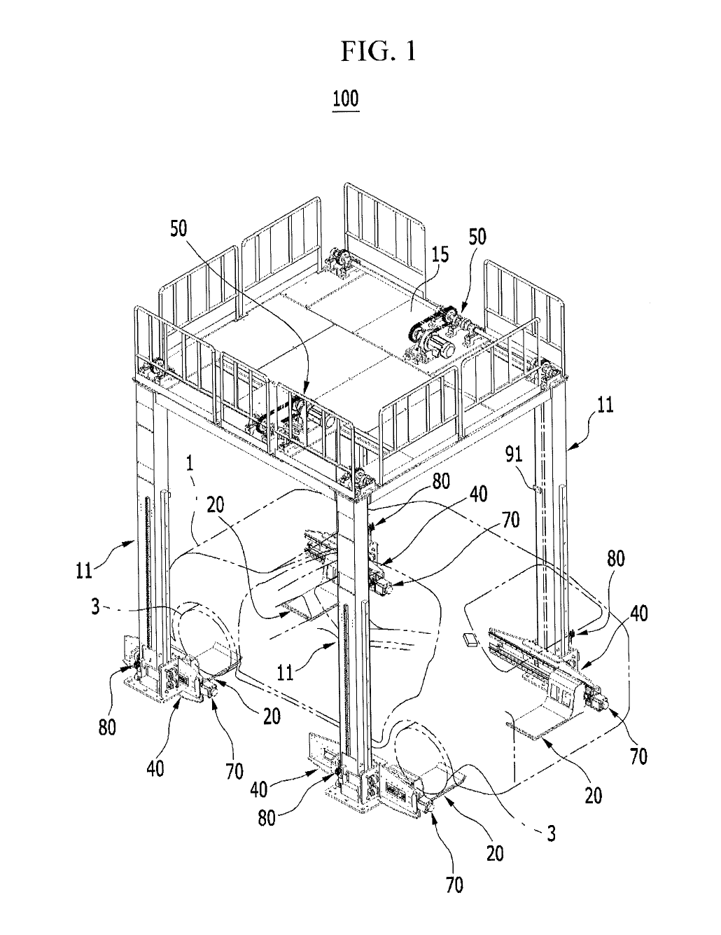

FIG. 1 is a perspective view illustrating an empty vehicle lifter for a vehicle assembly line according to various embodiments of the present invention. Referring to FIG. 1, an empty vehicle lifter 100 for a vehicle assembly line according to an exemplary embodiment of the present invention may be applied to a vehicle assembly line where an under body of a vehicle in an empty vehicle condition, which is conveyed along a given route in an automotive design component assembly process, is fastened and assembled, and repair work on design components is performed.

Here, the empty vehicle condition means a condition in which an empty vehicle weight of the vehicle may be satisfied, that is, a condition in which all design components including wheels, tires, and the like are mounted to a vehicle body, and may also mean a condition in which components associated with driving operations of the wheels are mounted to the vehicle body.

The empty vehicle lifter 100 according to various embodiments of the present invention serves to lift the vehicle in an empty vehicle condition, for performing work for fastening and assembling the under body of the vehicle, and repair work on the design components, in a case in which it is difficult to implement a work condition of the vehicle in an empty vehicle condition, which uses a tire ground contact type overhead hanger, due to an equipment space and excessive remodeling costs in a design component assembly line.

For example, the work for fastening and assembling the under body of the vehicle in an empty vehicle condition may include work for fastening a trailing arm, work for fastening a shock absorber lower end, work for fastening a roll rod bracket, work for mounting a seal side molding, work for mounting an undercover, and the like.

Further, the repair work on automotive design components may include work for repairing a rear floor undercover, work for repairing a seal side molding, and the like.

The empty vehicle lifter 100 for a vehicle assembly line according to various embodiments of the present invention has a structure that may ensure a working space for fastening/assembling the under body of the vehicle in an empty vehicle condition, and performing repair work on the design components.

That is, various embodiments of the present invention provides the empty vehicle lifter 100 for a vehicle assembly line which may allow the work for assembling the under body of the vehicle in an empty vehicle condition and the repair work on the design components to be easily performed while avoiding interference with working tools and interference with a worker.

To this end, the empty vehicle lifter 100 for a vehicle assembly line according to various embodiments of the present invention basically includes post frames 11, a ceiling frame 15, tire ground contact units 20, sliders 40, lift units 50, wheel base adjustment units 70, and position fixing units 80.

The post frames 11 and the ceiling frame 15 serve to support various types of constituent elements, which will be described below, and have accessory elements such as brackets, blocks, plates, housings, and collars for supporting the constituent elements. Because the accessory elements serve to install the respective constituent elements to the post frames 11 and the ceiling frame 15, the accessory elements will be collectively referred to as frames in various embodiments of the present invention except for an exceptional case.

The post frames 11 are vertically or substantially vertically installed on a floor of a working place on a route along which a vehicle 1 in an empty vehicle condition is moved. The post frames 11 are installed at four points on the floor of the working place while corresponding to the wheels of the vehicle 1.

For example, the aforementioned post frame 11 may be formed in a hollow square column shape that has an opened upper end, and a flange formed on a lower end portion thereof.

Further, the ceiling frame 15 is provided to install the lift unit 50, which will be further described below, and installed to be connected to upper end portions of the post frames 11. The ceiling frame 15 may be provided in a plate or substantially plate shape that connects the upper end portions of the post frames 11.

In various embodiments of the present invention, the tire ground contact units 20 serve to support (ground contact) wheel tires 3 of the vehicle 1, and are installed on the post frames 11 through the sliders 40, which will be further described below, so as to be movable upward and downward, respectively.

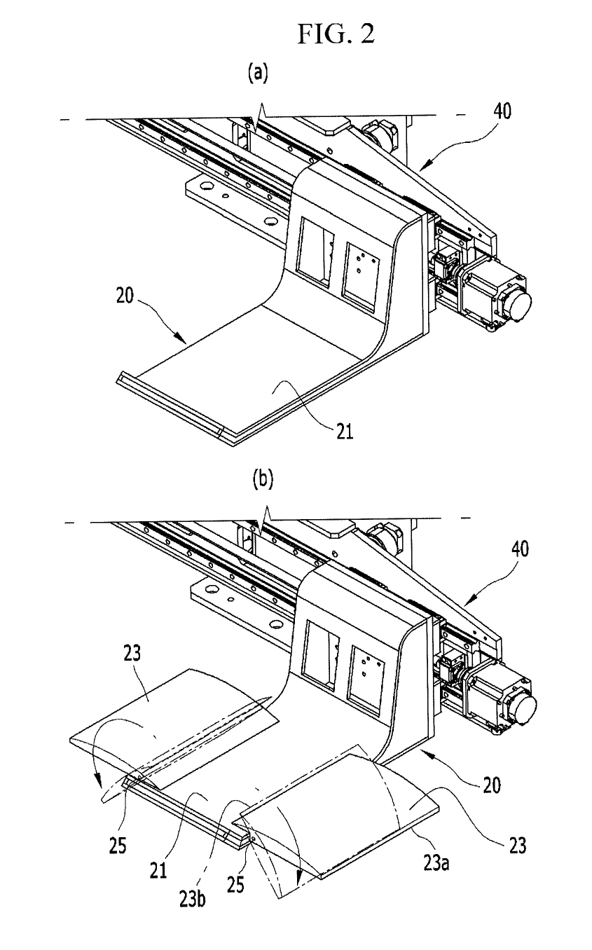

FIG. 2 including FIGS. 2(a) and 2(b) is a view illustrating a tire ground contact unit that is applied to an empty vehicle lifter for a vehicle assembly line according to various embodiments of the present invention. Referring to FIGS. 1 and 2, the tire ground contact unit 20 according to various embodiments of the present invention includes a ground contact base 21 with which the wheel tire 3 of the vehicle comes into contact.

In addition, in various embodiments of the present invention, the tire ground contact unit 20 may further include stopper members 23 that are hingedly coupled to both front and rear sides (based on a forward and rearward direction of the vehicle) of the ground contact base 21, respectively, as illustrated in FIG. 2B.

The ground contact base 21 is a portion on which the wheel tire 3 of the vehicle is seated (ground contact), is formed in a plate or substantially plate shape, and may be installed to be connected to the slider 40 that will be further described below.

The stopper members 23 are rotatably coupled to both front and rear sides of the ground contact base 21 by hinge pins 25. The stopper member 23 is formed in a plate or substantially plate shape that guides the wheel tire 3 of the vehicle 1 onto the ground contact base 21. Here, the stopper members 23 may be rotatably coupled to both front and rear sides of the ground contact base 21 by the hinge pins 25.

An outer portion 23a of the stopper member 23 guides the wheel tire 3 onto the ground contact base 21 in a state in which the ground contact base 21 is in contact with the floor of the working place, the stopper member 23 is rotated about the hinge pin 25 by its own weight when the ground contact base 21 is moved upward, and an inner portion 23b of the stopper member 23 may support front and rear portions of the wheel tire 3.

Referring to FIG. 1, in various embodiments of the present invention, the slider 40 serves to move the tire ground contact unit 20 upward and downward with respect to the post frame 11.

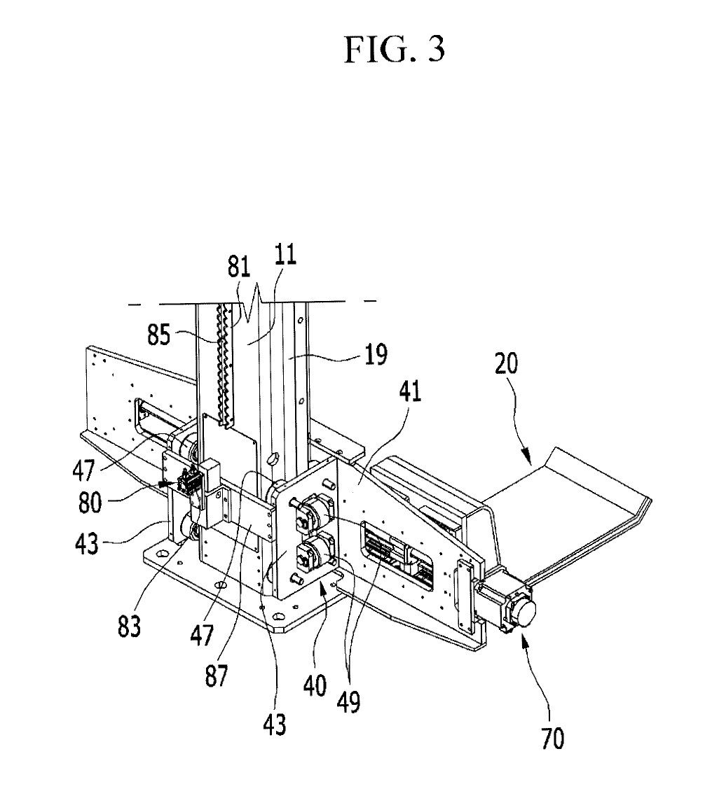

FIG. 3 is a view illustrating a slider that is applied to an empty vehicle lifter for a vehicle assembly line according to various embodiments of the present invention. Referring to FIGS. 1 and 3, the slider 40 according to various embodiments of the present invention is installed to be connected with the tire ground contact unit 20, and may be coupled to the post frame 11 so as to be slidable upward and downward.

To this end, guide rails 19, which guide the upward and downward movement of the slider 40, are installed on front and rear surfaces of the post frame 11 based on the forward and rearward direction of the vehicle 1, respectively. The guide rail 19 has a block shape, is disposed on the post frame 11 in an upward and downward direction, and installed on each of the front and rear surfaces of the post frame 11.

Meanwhile, the slider 40 includes a main slide bracket 41 which is disposed in the forward and rearward direction of the vehicle 1 while corresponding to an inner surface (a side surface directed toward a location where the vehicle is positioned) of the post frame 11, and a pair of sub-slide brackets 43 which is installed on the main slide bracket 41 while corresponding to the front and rear surfaces of the post frame 11, respectively.

The main slide bracket 41 serves to support the tire ground contact unit 20 and the wheel base adjustment unit 70, which will be further described below, and may be connected with the lift unit 50 (see FIG. 1).

The main slide bracket 41 is formed in a plate or substantially plate shape that has a predetermined width and a predetermined length in the forward and rearward direction of the vehicle 1. Further, the tire ground contact unit 20 and the wheel base adjustment unit 70 may be provided on the inner surface (a side surface directed toward a location where the vehicle is positioned) of the main slide bracket 41.

The sub-slide brackets 43 serve to support the guide rails 19 of the post frame 11, have a plate or substantially plate shape, and may be installed on an outer surface of the main slide bracket 41 with the post frame 11 interposed therebetween.

Meanwhile, a plurality of first guide rollers 47 and a plurality of second guide rollers 49, which are rotated along the guide rails 19 and guide the slider 40 in the upward and downward direction, are installed on the slider 40.

The first guide rollers 47 are rotatably installed on the sub-slide brackets 43 of the slider 40, and may be installed on the sub-slide brackets 43 that correspond to the front and rear surfaces of the post frame 11, respectively. The first guide rollers 47 are in rolling contact with both side surfaces of the guide rails 19.

Further, the second guide rollers 49 may be installed while penetrating the sub-slide brackets 43.

Referring to FIG. 1, in various embodiments of the present invention, the lift unit 50 serves to provide lift drive power to the slider 40 so as to move the slider 40, which supports the tire ground contact unit 20, upward and downward along the post frame 11. The lift unit 50 is installed on the ceiling frame 15, and connected with the slider 40 through the post frame 11.

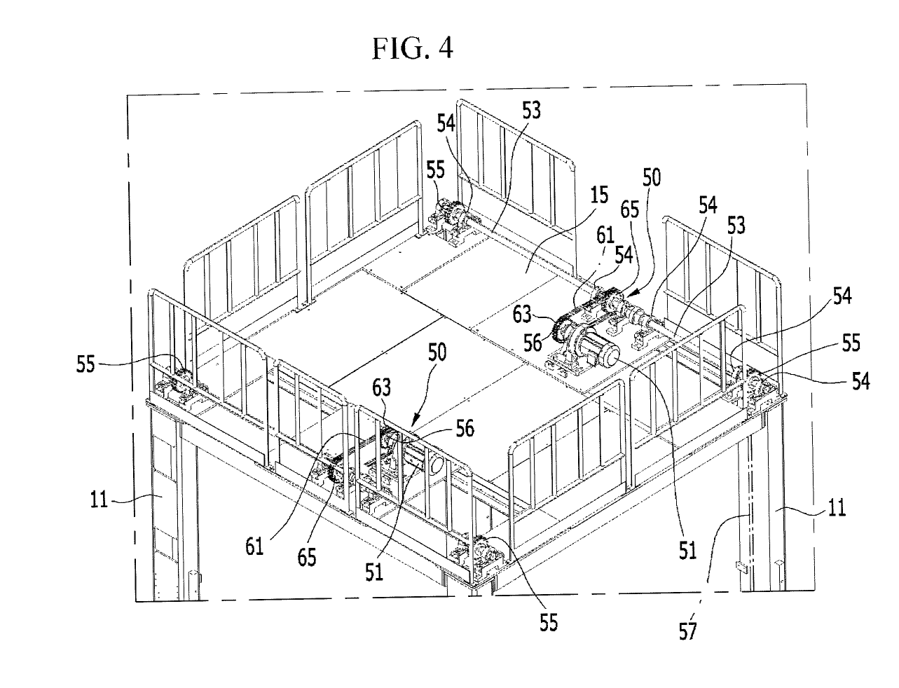

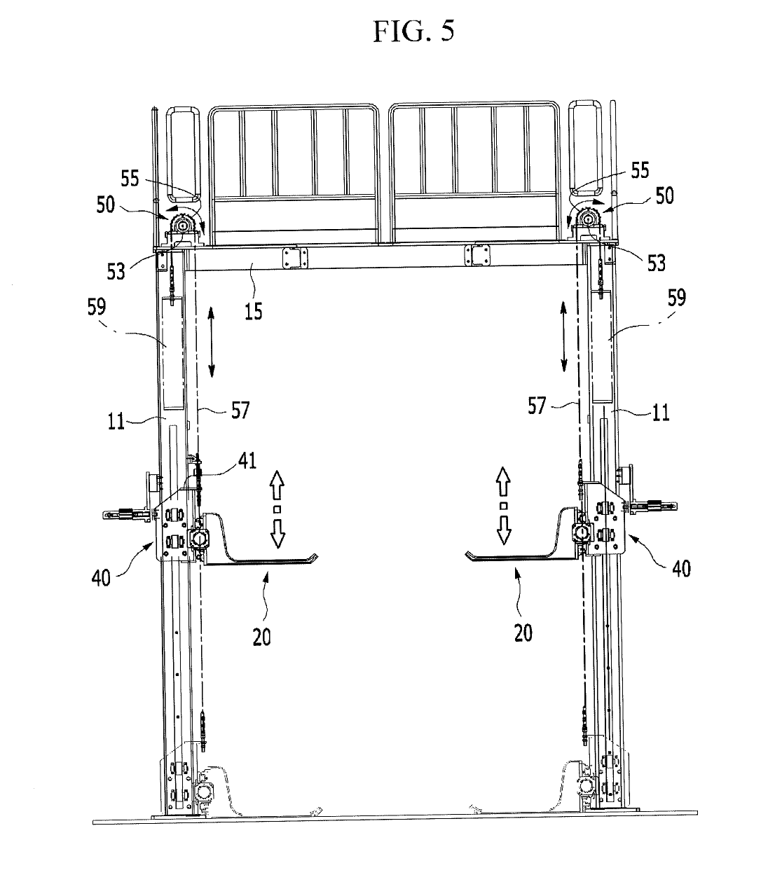

FIGS. 4 and 5 are views illustrating a lift unit that is applied to an empty vehicle lifter for a vehicle assembly line according to various embodiments of the present invention. Referring to FIGS. 4 and 5 together with FIG. 1, in various embodiments of the present invention, the lift unit 50 includes a drive motor 51, a rotation shaft 53, a lift sprocket 55, a lift chain 57, and a weight member 59.

The drive motors 51 may be installed on the upper surface of the ceiling frame 15 between one pair of post frames 11, and between the other pair of post frames 11, among the four post frames 11, respectively.

The rotation shaft 53 is rotatably installed on an upper portion of the ceiling frame 15 by a plurality of bearings 54. Here, the rotation shaft 53 may be provided as a single shaft, or two or more shafts that are integrally connected with each other through joints.

Further, the rotation shaft 53 may be connected with a drive shaft 56 of the drive motor 51 through a driving chain 61. A driving sprocket 63 is installed on the drive shaft 56 of the drive motor 51, and a driven sprocket 65, which corresponds to the driving sprocket 63, is installed on the rotation shaft 53. The driving sprocket 63 and the driven sprocket 65 may be connected through the driving chain 61.

The lift sprocket 55 is a power transmission mechanism for transmitting rotational force of the drive motor 51 to the slider 40 through the rotation shaft 53, and the lift sprockets 55 may be installed on both end portions of the rotation shaft 53.

The lift chain 57 is chain-coupled to the lift sprocket 55, and one end portion of the lift chain 57 is connected to the main slide bracket 41 of the slider 40.

The weight member 59 is a weight body that provides tension to the lift chain 57 by its own weight when the slider 40 is moved upward and downward, and the weight member 59 is connected with the other end portion of the lift chain 57, and may smoothly move the slider 40 upward and downward when the slider 40 is moved upward and downward by the weight of the weight member 59.

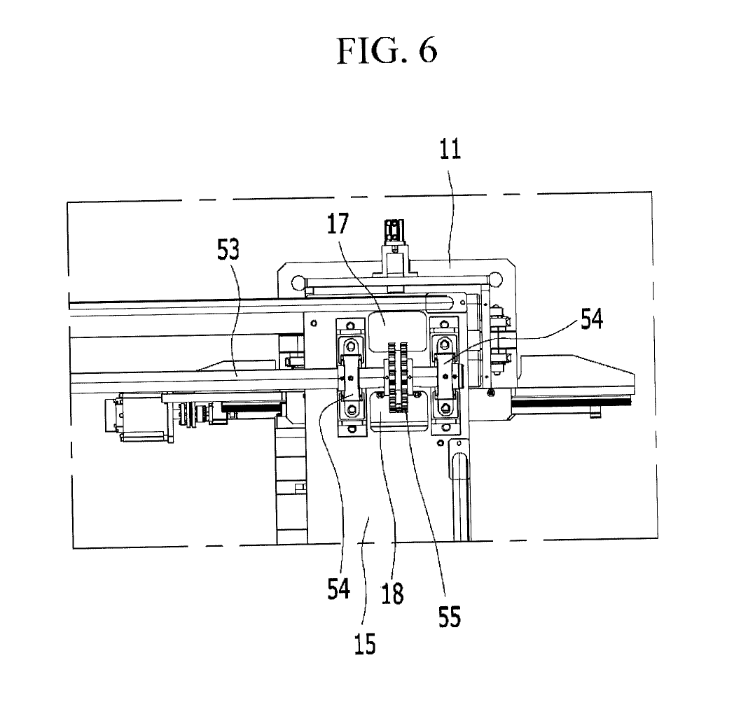

As illustrated in FIG. 6, a first guide hole 17, which guides the lift chain 57 to an inner space of the post frame 11, is formed in the ceiling frame 15, and a second guide hole 18, which guides the lift chain 57 to an outer space of the post frame 11, is formed in the ceiling frame 15.

Referring to FIG. 1, in various embodiments of the present invention, the wheel base adjustment unit 70 serves to reciprocally move the tire ground contact unit 20 in the forward and rearward direction of the vehicle 1 so that the tire ground contact unit 20 corresponds to a wheel base of the vehicle 1. The wheel base adjustment unit 70 is connected to the tire ground contact unit 20 and the slider 40. Here, the wheel base means a distance between a front wheel and a rear wheel of the vehicle 1, and the wheel base may vary according to the type of vehicle.

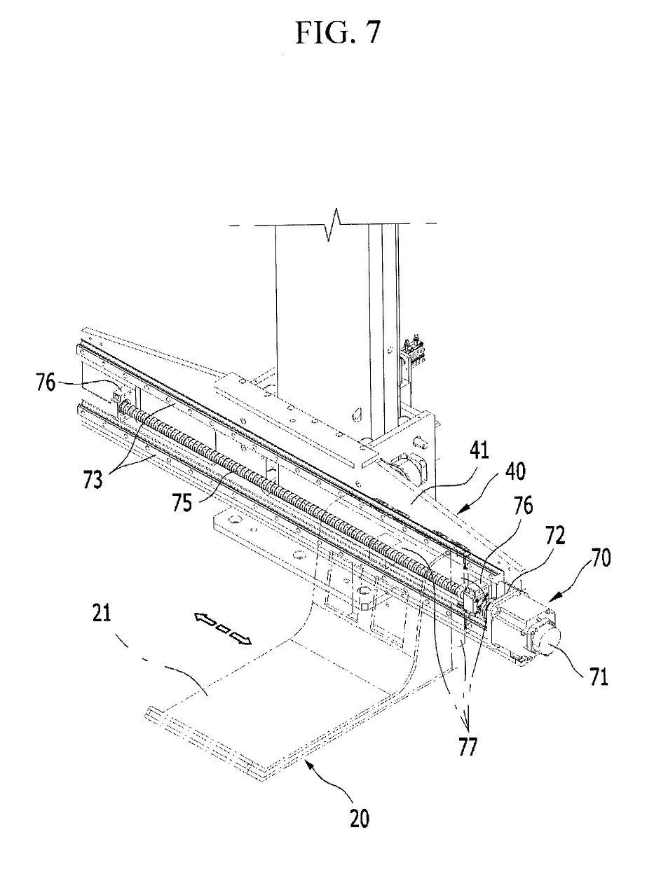

FIG. 7 is a view illustrating a wheel base adjustment unit that is applied to an empty vehicle lifter for a vehicle assembly line according to various embodiments of the present invention. Referring to FIGS. 1 and 7, in various embodiments of the present invention, the wheel base adjustment unit 70 includes a servo motor 71, a rail block 73, a lead screw 75, and movable blocks 77.

The servo motor 71 is installed on the main slide bracket 41 of the slider 40 through the fixing bracket 72.

The rail blocks 73 are installed inside the main slide bracket 41 in a length direction (the forward and rearward direction of the vehicle) of the main slide bracket 41, and a pair of rail blocks 73 is installed in parallel to be spaced apart from each other.

The lead screw 75 is disposed in parallel with the rail blocks 73 between the rail blocks 73, connected to a drive shaft of the servo motor 71, and rotatably installed inside the main slide bracket 41 through bearings 76.

Here, the bearings 76 serve to rotatably support both sides of the lead screw 75, and are installed inside the main slide bracket 41.

The movable blocks 77 are installed on the ground contact base 21 of the tire ground contact unit 20, coupled to the lead screw 75 in a threaded connection manner, and slidably coupled to the rail blocks 73. That is, a plurality of movable blocks 77 is installed on the ground contact base 21, any one of the movable blocks 77 may be coupled to the lead screw 75 in a threaded connection manner, and the remainders may be slidably coupled to the rail blocks 73.

Therefore, when the servo motor 71 is operated, the lead screw 75 is rotated, and the movable block 77 is rectilinearly moved in a length direction of the main slide bracket 41 while being guided by the rail block 73 along the lead screw 75, such that the tire ground contact unit 20 may be moved in the forward and rearward direction of the vehicle 1 while corresponding to a predetermined wheel base of the vehicle 1.

Referring to FIG. 1, in various embodiments of the present invention, the position fixing unit 80 serves to fix a position of the tire ground contact unit 20 that is moved upward by the slider 40, and serves to selectively fix the slider 40 to the post frame 11.

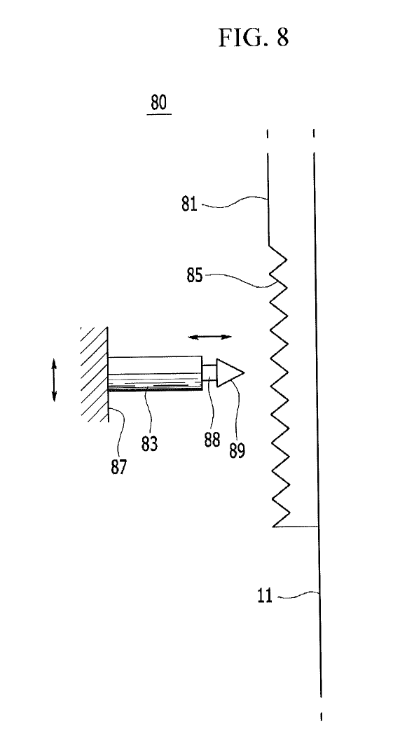

FIG. 8 is a view illustrating a position fixing unit that is applied to an empty vehicle lifter for a vehicle assembly line according to various embodiments of the present invention. Referring to FIGS. 3 and 8 together with FIG. 1, the position fixing unit 80 includes a latch member 81, and a locating cylinder 83. The latch member 81 is installed in the upward and downward direction outside the post frame 11, and latch grooves 85 having a serrated shape are continuously formed in the upward and downward direction. The locating cylinder 83 is a hydraulic or pneumatic cylinder, and installed on a connecting bracket 87 that connects the sub-slide bracket 43 of the slider 40.

The locating cylinder 83 has an operation rod 88 that is moved forward and rearward by hydraulic pressure or pneumatic pressure, and a stopper 89, which may be coupled to the latch groove 85 of the latch member 81, is installed at a tip of the operation rod 88.

That is, during a process in which the slider 40 is moved along the post frame 11 at a predetermined height, the stopper 89 is moved rearward by the operation rod 88 of the locating cylinder 83, and moved toward the outer surface of the post frame 11 by an operation of the operation rod 88 that is moved forward by the locating cylinder 83, and as a result, the stopper 89 may be coupled to the latch groove 85 of the latch member 81.

Therefore, in various embodiments of the present invention, in a state in which the slider 40 is moved at a predetermined height along the post frame 11, as described above, the stopper 89 is coupled to the latch groove 85 of the latch member 81 by the locating cylinder 83, thereby fixing a position of the tire ground contact unit 20 that is moved upward by the slider 40.

Meanwhile, referring to FIG. 1, in various embodiments of the present invention, a stopping block 91, which restricts a maximum raised position of the tire ground contact unit 20 that is moved upward by the slider 40, is installed on each post frame 11. In various embodiments of the present invention, the stopping block 91 serves to prevent the slider 40 from being moved when the slider 40 is moved to a maximum height along the post frame 11.

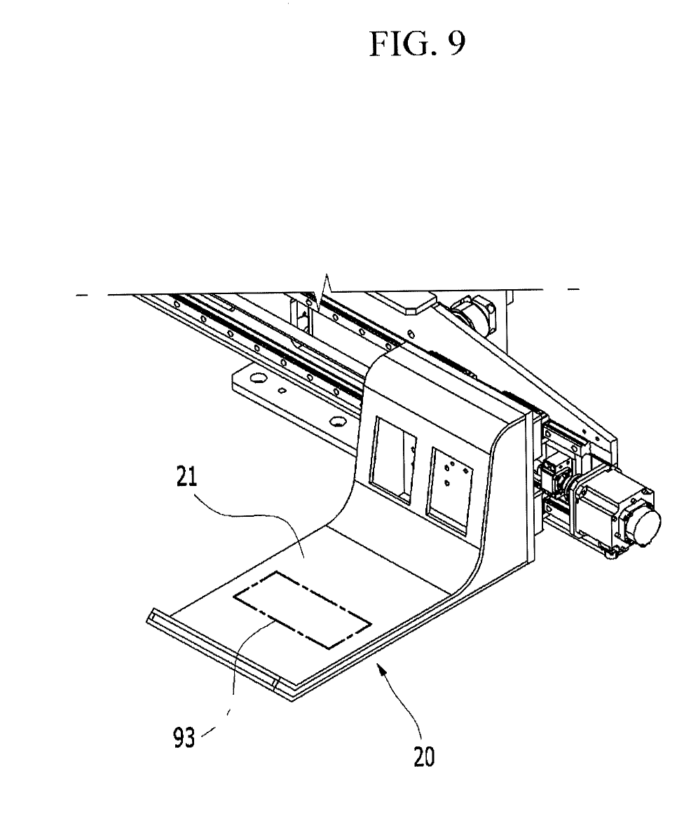

In addition, in various embodiments of the present invention, a weigher 93, which measures an overall weight of the vehicle 1, is installed on the ground contact base 21 of the tire ground contact unit 20, as illustrated in FIG. 9. The weigher 93 is embedded in the ground contact base 21 of the tire ground contact unit 20, and measures a total weight of the vehicle 1, the wheel tire 3 of which is in contact with the ground contact base 21. The weigher 93 measures the weight of the vehicle 1, and may transmit the measured value to a separate server or a vehicle data history management system. Since the weigher 93 is provided as a vehicle weight measuring apparatus that is known in the corresponding industrial field, a more detailed description of a configuration thereof will be omitted in the present specification.

Hereinafter, an operation of the empty vehicle lifter 100 for a vehicle assembly line according to various embodiments of the present invention will be described in detail with reference to the aforementioned drawings.

First, in various embodiments of the present invention, in the automotive design component assembly process, the vehicle 1 in an empty vehicle condition in which all or substantially all design components including the wheels and the tires are mounted to the vehicle body is moved to the empty vehicle lifter 100. In this case, the vehicle 1 in an empty vehicle condition may be moved to the empty vehicle lifter 100 by a driving manipulation by a worker.

Prior to the movement of the vehicle 1, the worker sets the type of vehicle using a control panel (not illustrated in the drawings), and a controller (not illustrated in the drawings) operates the wheel base adjustment unit 70 depending on the set type of vehicle, and moves the tire ground contact unit 20 forward and rearward while corresponding to a predetermined wheel base of the vehicle 1.

That is, when the servo motor 71 of the wheel base adjustment unit 70 is operated, the lead screw 75 is rotated, and the movable block 77 is moved forward and rearward along the lead screw 75 while being guided by the rail block 73, such that the tire ground contact unit 20 is moved to a position that corresponds to a predetermined wheel base of the vehicle 1.

In this case, the ground contact base 21 of the tire ground contact unit 20 may be moved forward and rearward through the wheel base adjustment unit 70 in a state in which the ground contact base 21 is in contact with the floor of the working place, and the ground contact base 21 may be moved forward and rearward by the wheel base adjustment unit 70 after being moved upward for a predetermined section through a process which will be further described below.

In this state, in various embodiments of the present invention, the vehicle 1 in an empty vehicle condition is moved to the inside of the post frames 11 by a driving manipulation of the worker, and the wheel tire 3 of the vehicle 1 is seated (ground contact) on the ground contact base 21 of each of the tire ground contact units 20. In this case, the wheel tire 3 of the vehicle 1 climbs the outer portion 23a of the stopper member 23, and may be seated on the ground contact base 21.

Moreover, in various embodiments of the present invention, in a state in which the wheel tire 3 of the vehicle 1 is in contact with the ground contact base 21 of the tire ground contact unit 20, as described above, a weight of the vehicle is measured by the weigher 93 embedded in the ground contact base 21, and the measured value is transmitted to the server or the vehicle data history management system.

Thereafter, in various embodiments of the present invention, in order to raise the tire ground contact unit 20 with which the wheel tire 3 of the vehicle 1 is in contact, and lift the vehicle upward, the lift unit 50 is operated. That is, specifically describing in detail an operation of the lift unit 50, in various embodiments of the present invention, a control signal is first applied to the drive motor 51 of the lift unit 50 through the controller.

Then, the drive shaft 56 of the drive motor 51 is rotated in one direction, and the rotation shaft 53 is also rotated in one direction as the drive shaft 56 is rotated in one direction. In this case, the driving sprocket 63 installed on the drive shaft 56 of the drive motor 51 and the driven sprocket 65 installed on the rotation shaft 53 are connected through the driving chain 61.

Therefore, when the drive shaft 56 of the drive motor 51 is rotated in one direction, the rotation shaft 53 is rotated in one direction through the driving sprocket 63, the driven sprocket 65, and the driving chain 61. When the rotation shaft 53 is rotated in one direction as described above, the lift sprockets 55 installed on both end portions of the rotation shaft 53 are also rotated in one direction.

As the lift sprockets 55 are rotated in one direction as described above, the slider 40 is lifted upward by the lift chain 57, and the tire ground contact unit 20 is also moved upward along the guide rail 19 of the post frame 11. In this case, the slider 40 may be more easily lifted upward by the weight of the weight member 59.

Here, the stopper 89 of the position fixing unit 80 is in a state in which the stopper 89 is moved rearward in a direction in which the stopper 89 is moved far away from the latch groove 85 of the latch member 81 by the operation rod 88 of the locating cylinder 83. Further, the weight member 59 is moved downward inside the post frame 11.

In addition, the first guide rollers 47 of the slider 40 are in rolling contact with both surfaces of the guide rail 19, and the second guide rollers 49 are in rolling contact with an opposite surface of a fixed side of the guide rail 19, such that the slider 40 may be moved upward along the guide rail 19.

Furthermore, as the tire ground contact unit 20 is moved upward together with the slider 40, the stopper member 23 is rotated about the hinge pin 25 by its own weight, and the inner portion 23b of the stopper member 23 may support front and rear sides of the wheel tire 3.

Meanwhile, when the slider 40 is moved upward to a predetermined position along the guide rail 19 of the post frame 11, as described above, the aforementioned drive motor 51 of the lift unit 50 is stopped.

Next, in various embodiments of the present invention, the stopper 89 of the position fixing unit 80 is coupled to the latch groove 85 of the latch member 81 by moving the operation rod 88 of the locating cylinder 83 forward.

Accordingly, in various embodiments of the present invention, a position of the tire ground contact unit 20, which is moved upward by the slider 40, may be fixed by the position fixing unit 80. In addition, when the slider 40 is moved to a maximum height along the post frame 11, the movement of the slider 40 may be blocked by the stopping block 91.

In various embodiments of the present invention, in a state in which the slider 40 is moved upward along the post frame 11, and the vehicle 1 is lifted to a predetermined height by the tire ground contact unit 20, through the aforementioned processes, the work for fastening/assembling the under body of the vehicle 1 in an empty vehicle condition and the repair work on the design components may be performed.

For example, in various embodiments of the present invention, the work for fastening and assembling the under body such as work for fastening a trailing arm, work for fastening a shock absorber lower end, work for fastening a roll rod bracket, work for mounting a seal side molding, work for mounting an undercover, and the like may be performed in a state in which the vehicle 1 in an empty vehicle condition is lifted.

Further, in various embodiments of the present invention, work for repairing design components such as the rear floor undercover and the seal side molding may be performed in a state in which the vehicle 1 in an empty vehicle condition is lifted.

Meanwhile, because processes of moving the vehicle 1 downward after performing the work for fastening/assembling the under body of the vehicle 1 and the repair work on the design components are performed, as described above, are performed in the order inverse to that of the aforementioned processes, a detailed description thereof will be omitted hereinafter.

For example, while the drive shaft 56 of the drive motor 51 of the lift unit 50 is rotated in the other direction, the slider 40 may be moved downward along the guide rail 19 of the post frame 11 together with the tire ground contact unit 20.

According to the empty vehicle lifter 100 for a vehicle assembly line according to various embodiments of the present invention, the vehicle 1 may be moved upward and downward by moving the tire ground contact unit 20, which allows the wheel tire 3 of the vehicle 1 to be in contact with the tire ground contact unit 20, upward and downward through the slider 40 by an operation of the lift unit 50.

Accordingly, in various embodiments of the present invention, the vehicle in an empty vehicle condition is lifted, thereby performing work for fastening and assembling the under body of the vehicle, and repair work on the design components, in a case in which it is difficult to implement a working environment condition of the vehicle in an empty vehicle condition, which uses a tire ground contact type overhead hanger, due to an equipment space and excessive remodeling costs in the automotive design component assembly process.

In addition, in various embodiments of the present invention, a working space for performing the work for fastening and assembling the under body of the vehicle 1 in an empty vehicle condition and the repair work on the design components may be ensured, and interference with the working tools and interference with the worker may be avoided, thereby easily performing the work for assembling the under body of the vehicle in an empty vehicle condition and the repair work on the design components.

For convenience in explanation and accurate definition in the appended claims, the terms “upper” or “lower”, “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An empty vehicle lifter for a vehicle assembly line, which lifts a vehicle in an empty vehicle condition in a vehicle assembly line, the empty vehicle lifter comprising:
four post frames which are substantially vertically installed on a floor of a working place while corresponding to wheels of the vehicle;
a ceiling frame which is connected to upper end portions of the post frames;
a tire ground contact unit which supports a wheel tire of the vehicle, and is installed on each of the post frames so as to be movable upward and downward; and
a lift unit which is installed on the ceiling frame so as to move the tire ground contact unit upward and downward.

2. The empty vehicle lifter of claim 1, further comprising:
a slider which is connected with the tire ground contact unit, coupled to a respective post frame so as to be slidable upward and downward, and connected with the lift unit through the respective post frame.

3. The empty vehicle lifter of claim 2, further comprising:
a wheel base adjustment unit which is connected with the slider and the tire ground contact unit in order to move the tire ground contact unit in a forward and rearward direction of the vehicle while corresponding to a predetermined wheel base of the vehicle.

4. The empty vehicle lifter of claim 2, further comprising:
a position fixing unit which is installed on the slider and the respective post frame, and fixes a raised position of the slider.

5. The empty vehicle lifter of claim 1, wherein:
the post frames are formed in a hollow square column shape.

6. The empty vehicle lifter of claim 1, wherein the tire ground contact unit includes:
a ground contact base with which the wheel tire of the vehicle is in contact; and
stopper members which are hingedly and rotatably coupled to front and rear sides of the ground contact base.

7. The empty vehicle lifter of claim 6, wherein:
the stopper members support front and rear sides of the wheel tire through inner portions thereof while being rotated about hinge points by their own weights when the tire ground contact unit is moved upward.

8. The empty vehicle lifter of claim 2, wherein the lift unit includes:
drive motors which are installed on the ceiling frame between one pair of post frames, and between the other pair of post frames, respectively;
a rotation shaft which is connected with each of the drive motors through a driving chain, and rotatably installed on the ceiling frame;
a lift sprocket which is installed on the rotation shaft;
a lift chain which is coupled to the lift sprocket, and has one end portion that is connected to the slider; and
a weight member which is connected to the other end portion of the lift chain.

9. The empty vehicle lifter of claim 8, wherein:
a driving sprocket is installed on a drive shaft of a respective drive motor, a driven sprocket is installed on the rotation shaft that corresponds to the driving sprocket, and
the driving chain connects the driving sprocket and the driven sprocket.

10. The empty vehicle lifter of claim 8, wherein the ceiling frame has a first guide hole which guides the lift chain to an inside of the respective post frame, and a second guide hole which guides the lift chain to an outside of the respective post frame.

11. The empty vehicle lifter of claim 2, wherein:
guide rails are installed on front and rear surfaces of the respective post frame in an upward and downward direction.

12. The empty vehicle lifter of claim 11, wherein the slider includes:
a main slide bracket which is disposed in a forward and rearward direction of the vehicle while corresponding to an inside of the respective post frame; and
sub-slide brackets which are installed on the main slide bracket while corresponding to front and rear sides of the respective post frame.

13. The empty vehicle lifter of claim 12, wherein:
a plurality of first guide rollers is installed on the sub-slide bracket to be in rolling contact with both surfaces of a respective guide rail, and
a plurality of second guide rollers is installed to penetrate the sub-slide bracket so as to be in rolling contact with the respective guide rail.

14. The empty vehicle lifter of claim 3, wherein the wheel base adjustment unit includes:
a servo motor which is installed on the slider;
at least one rail block which is installed on the slider in the forward and rearward direction of the vehicle;
a lead screw which is disposed substantially in parallel with the rail block, connected with the servo motor, and rotatably installed on the slider; and
a movable block which is connected with the tire ground contact unit, and coupled to the lead screw in a threaded connection manner.

15. The empty vehicle lifter of claim 4, wherein the position fixing unit includes:
a latch member which is installed in an upward and downward direction outside the respective post frame, and has latch grooves that are continuously formed in the upward and downward direction; and
a locating cylinder which is installed on the slider, and has a stopper which is coupled to the latch groove, and installed on an end portion of an operation rod.

16. The empty vehicle lifter of claim 2, wherein:
a stopping block, which restricts a maximum raised position of the slider, is installed on each of the post frames.

17. The empty vehicle lifter of claim 1, further comprising:
a weigher which is embedded in the tire ground contact unit, and measures a weight of the vehicle.
